(19) United States
(12) Patent Application Publication
(10) Pub. No.: US 2005/0224443 A1
(43) Pub. Date: Oct. 13, 2005

(54) Nursing bottle

(76) Inventors: Jean-Louis Raymond, Saint-Laurent-de-la-Salanque (FR); Jean-Charles Craveur, Coulaines (FR)

Correspondence Address: EGBERT LAW OFFICES, 412 MAIN STREET, 7TH FLOOR, HOUSTON, TX, 77002, US

(21) Appl. No.: 10/516,212

(22) PCT Filed: May 30, 2003
(86) PCT No.: PCT/FR03/01638

§ 371 Date: May 13, 2005

(30) Foreign Application Priority Data
May 30, 2002 (FR) 02/06621
Dec. 31, 2002 (FR) 02/16889

(51) Int. Cl. A61J 9/00; A61J 11/00

(52) U.S. Cl. 215/11.1

(57) ABSTRACT

A nursing bottle includes an outer open body which houses a flexible casings that is intended co contain the fluid food product, a flexible nipple which is used to dispense the product, a check valve which is disposed between the opening in the casings and the nipple and, close to the end of the nipple which is pierced with at least one slit, a second check valve which can open and close depending on whether or not suction and/or pressure respectively is/are being applied. The nipple is provided with a mechanism to enable the slit to switch from a closed position in an impervious manner to an open position such that the food product can pass therethrough when a predetermined pressure is exerted by the mandible. In this way, the slit forms the second check valve.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The object of the present invention is a nursing-bottle device for feeding an infant.

The purpose of the nursing-bottle device according to the invention is in particular to provide a functional nursing-bottle device allowing to feed an infant in a way adopting the physical and mechanical processes of breast-feeding.

The muscular work of sucking the child must perform to draw the milk from the mother's breast is one of the elements favoring the child's development and, more particularly, the growth of the jawbones. This muscular effort of sucking is to be assimilated to performing milking where the pressure on the nipple causes the extraction of milk, the aspiration effort being mainly aimed only at maintaining contact.

### BACKGROUND OF THE INVENTION

Now, the presently used classical nursing-bottle devices require no or little effort by the infant, which is therefore prejudicial to the child's development.

Thus, we will cite the nursing bottle disclosed in GB 2,169,210, which is recommended for children with limited sucking capacities, because it has external pressing means allowing the mother to propel the liquid food into the child's mouth. Though this nursing bottle allows to feed the child, it is not favorable for the child's development, and in particular for the development of the jawbones.

Furthermore, the feeding with milk by means of a classical nursing-bottle has other drawbacks, namely in that it favors air ingestion, because of the need for compensating-air intake into the nursing bottle. This air ingestion has a tendency to favor oral-ventilation training, i.e. a propensity of the child to breathe through the mouth and not through the nose. This oral breathing causes many health problems throughout the child's growth, which can persist once the child has become all adult, in the form of repeated colds and maxillo-facial problems, in particular orthodontic problems.

In order to cope with these various drawbacks, so-called physiological nursing-bottle devices have been provided, which try to adopt the breast-feeding conditions, i.e. by providing it with the same characteristics as those of the mother's breast.

There has thus been provided, in FR 568.653, a nursing bottle provided with a teat nipple adopting the shape of the end of a breast in that it includes an extended nipple pierced with a delivery channel, said nipple being massive, so that it cannot be crushed like a classical teat nipple, and the extraction of the liquid food can be performed only by aspiration of the same through the delivery channel, which remains permanently open, however with drawbacks, namely in that the air-ingestion problem is not solved, because of the need for air intake.

In order to cope with the air-ingestion problem, there has been proposed to control the air intake into the nursing bottle either at the level of the junction between teat nipple and receptacle, as in U.S. Pat. No. 5,791,503, U. S. Pat. No. 5,638,769 and U.S. Pat. No. 3 651 973, through a non-return valve system or at the level of the receptacle, as in U.S. Pat. No. 5,944,205, through a valve system. These devices, beside their relative complexity as regards some of them, though they allow limiting air ingestion, do not allow to adopt the characteristics of breast-feeding.

There is known another physiological nursing-bottle device, disclosed in EP 0,540,618, which is presently the most successful so-called physiological nursing-bottle device. It includes essentially an external body accommodating a flexible casing aimed at containing a fluid foodstuff, pressure-control means for the air pocket intercalated between said body and said casing, a flexible teat nipple allowing to dispense said product, a non-return valve arranged between the opening of said casing and said teat nipple, and finally a second non-return valve arranged in said teat nipple in the vicinity of the exit hole or holes for said product, said second valve being capable of opening and closing according to whether or not tightening is carried out, respectively.

The session of feeding with milk requires a starting phase which consists in filling with foodstuff the space separating the two valves, while controlling the pressure between the external body and the flexible casing. The next phase consists of the actual feeding with milk, in which the extraction of the foodstuff requires a pressing effort in order to overcome the, resistance of the two non-return valves. At the end of the suction, the closing of the second valve avoids air intake into the teat nipple which, because of the negative pressure brought about, is filled with foodstuff.

Thus, in order to draw the foodstuff, the child must make an effort similar to that made during breast-feeding, and which can be adjusted by action on the control means.

This nursing-bottle device has however drawbacks, namely from the viewpoint of its manufacturing, mainly as regards the second non-return valve.

The latter is made of a narrowing provided for inside the teat nipple and which forms the seat of an axially movable valve. The movable valve consists of a member with a diameter larger than the inner diameter of the narrowing, and which is arranged at the distal end of a part or core with a conical shape, the base of which is made integral with the body of the nursing bottle, and at least a portion of which is elastically distortable, in order to allow the axial mobility of the valve.

Now, besides the drawbacks related to the need for additional handling operations because of the presence of a part, namely the core which has be removed, cleaned, sterilized, then installed again, the users are increasingly more often faced with frequent dissociation of the valve and the narrowing, because of a pulling force exerted on the end of the teat nipple, which causes, in addition to the dysfunction of the nursing bottle, escapes of liquid food.

Furthermore, the presence of the control system is also a drawback during the cleaning and sterilization operations carried out on the nursing bottle.

### BRIEF SUMMARY OF THE INVENTION

The purpose of the present invention is to provide a physiological nursing-bottle device allowing to cope with the various above-mentioned drawbacks.

The nursing-bottle device according to the invention is of the type comprising an open external body accommodating a flexible casing aimed at containing the fluid foodstuff, a flexible teat nipple allowing to dispense said product, a non-return valve arranged between the opening of said casing and said teat nipple and, close to the end of said teat nipple, pierced with at least one slit, a second non-return valve capable of opening and closing according to whether or not a suction and/or pressure is carried out, respectively, and it is mainly characterized in that said teat nipple has means allowing that the slit can switch from an imperviously closed position to an open position, in order to authorize the passing through of said food product, under the action of a pressure of a predetermined value exerted by the mandible, so that said slit, associated with said means, forms said second non-return valve.

Thus, the second valve delivers the liquid food only under a certain pressure, which forces the child to make a muscular effort of propulsion and pressing with the mandible, thereby adopting perfectly the conditions of breast-feeding. This second valve is not a mere non-return valve, capable of preventing the liquid from exiting.

According to a first embodiment of the nursing-bottle device according to the invention, the means allowing that the slit can switch from an imperviously closed position to an open position in order to authorize the passing through of the food product, under the action of a pressure of a predetermined value exerted by the mandible consist of an extra thickness of the wall of the teat nipple in the area pierced with said slit in, association with the dimensional characteristics of said slit and the physical characteristics of the material used, such as namely its coefficients of elasticity.

For a given material, through selecting an extra thickness of the wall, for a given dimension of the slit, the resistance to opening of said slit, and hence the pressure value necessary for opening the latter, is changed. It is thus advantageously possible to make teat nipples the pressure threshold-value of which necessary to open the slit is different, and thus to provide teat nipples adapted each to a particular age.

It should be noted that the teat nipple is, preferably, provided with only one slit, but that there may of course be several of them.

According to a preferred execution of the first embodiment of the device according to the invention, the teat nipple is made out of silicone or natural rubber, and the extra thickness varies between 1.5 and 8 mm, while the length of the slit ranges between 1.5 and 8 mm.

According to a second embodiment of the nursing-bottle device according to the invention, the means allowing that the slit can switch from an imperviously closed position to an open position in order to authorize the passing through of the food product, under the action of a pressure of a predetermined value exerted by the mandible consist of an extra thickness of the wall of the teat nipple in an area peripheral to the one pierced with said slit, in association with the dimensional characteristics of said slit and the physical characteristics of the material used, such as in particular its coefficients of elasticity.

According to a preferred form of the second embodiment of the nursing-bottle device according to the invention, the extra thickness has the shape of a collar.

According to an additional feature of the second embodiment of the nursing-bottle device according to the invention, the collar is positioned in an area separating a nipple-like portion and a teat-like portion.

The nursing-bottle device according to the invention, irrespective of its embodiment, has many advantages, compared to the presently known physiological nursing bottles. It allows in particular to cope with the drawbacks of the one disclosed in EP 0,540,618, while maintaining the qualities of the latter.

Indeed, in addition to the obligation for the child to exert a pressure thanks to the mandibulo-lingual torque to achieve the delivery of the liquid food, the two valves avoid air ingestion and also allow to feed the child in all positions, even with the teat nipple oriented upwardly, and this always without air ingestion, which none of the nursing-bottle device known hitherto allows.

It should be noted that, advantageously, the two embodiments of the nursing-bottle device according to the invention can be combined, i.e. the teat nipple can include: a wall having, on the one hand, an extra thickness at the level of its area pierced with the slit and, on the other hand, an extra thickness in an area peripheral to the pierced one.

### BRIEF DESCRIPTION OF THE SEVERAL VIEWS OF THE DRAWINGS

The advantages and features of the device according to the invention will become clear from the following description, with reference to the attached drawing, which represents several non-restrictive embodiments of it.

In the attached drawing:

FIG. 1 represents a schematic cross-sectional view according to a median longitudinal plan and exploded view of a nursing-bottle device according to the invention.

FIG. 2 represents a schematic view at larger scale of a portion of the same device.

FIG. 3 consists of curves allowing to determine the possible flow-rate of extraction of the liquid according to the pressure exerted and the length of the slit for a classical teat nipple.

FIG. 4 consists of curves allowing to determine the possible flow-rate of extraction of the liquid according to the pressure exerted and the length of the slit for a teat nipple of a nursing bottle according to the invention.

FIG. 5 represents a schematic partial view of a second embodiment of the nursing-bottle device according to the invention.

### DETAILED DESCRIPTION OF THE INVENTION

When referring to FIG. 1, one can see that a nursing-bottle device according to the invention includes a body 1 of a tubular shape, having an opening 10 through which is inserted a flexible casing 2, also of a tubular shape, having an opening 20 for allowing the insertion of a liquid foodstuff.

The opening 10 of body 1 is edged by a rim 11, while the opening 20 of the casing 2 is surrounded by a collar 21 aimed at resting on the rim 11.

The body 1 is open, in order to allow controlling the air pressure, in this case it does not include any bottom. According to a variant, not shown, the body 1 includes a bottom and openings for controlling the air pressure.

The opening 20 of the casing 2 is closed by a non-return valve 3, in this case comprised of two parts, namely, on the one hand, a disc-like support 30 made out of rigid material, aimed at resting with its edge on the collar 21, and including in its center a hole 31 and, on the other hand, a membrane 32, also having the shape of a disc, made out of distortable flexible material, aimed at covering the support 30, pierced with holes 33, and including, internally, a protuberance 34 capable of hermetically closing the opening of the hole 31, which has a profile complementary to that of the protuberance 34, with a taper, so as to allow an easy opening. Advantageously, the protuberance 34 has the shape of a spherical cap.

The non-return valve 3 is crowned with a teat nipple 4 including, in a classical way, an outermost portion 40 pierced with a slit 41, a central room 42 and, at its base, an outer collar 43 aimed at entering into contact with the membrane 32 and at allowing maintaining the teat nipple 4, as well as maintaining the aggregate of superimposed parts, by means of a clamp ring 5 made integral with the body 1 by screwing-on.

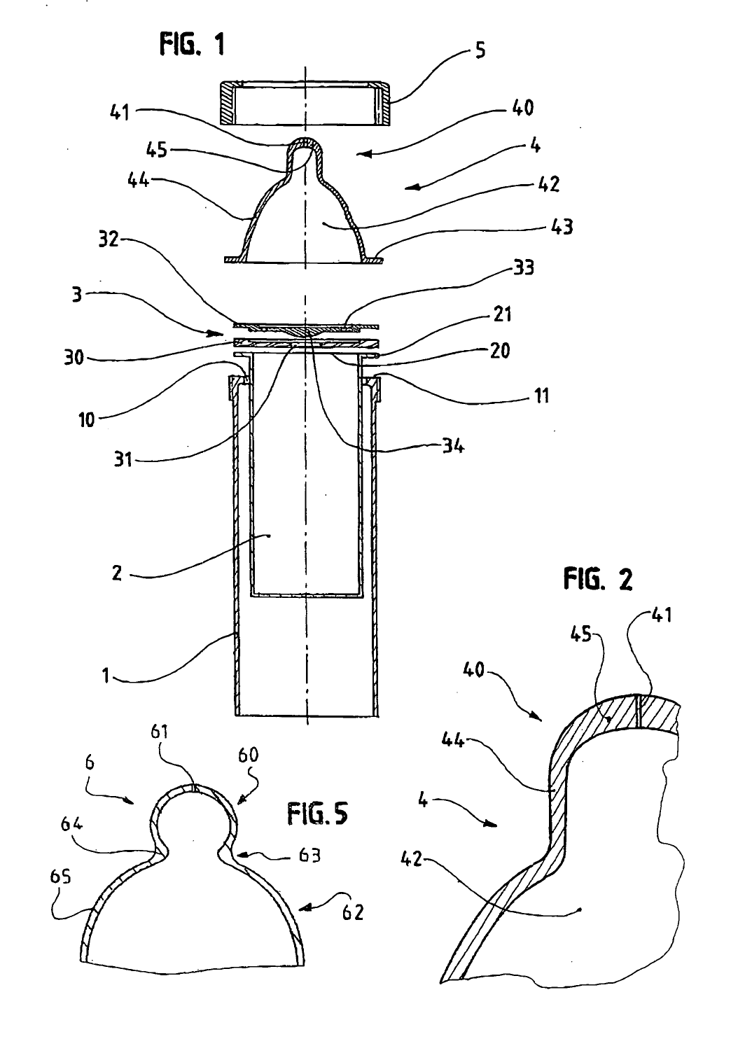

When referring now to FIG. 2, one can see a partial view of the teat nipple 4 of the nursing-bottle device according to the invention and, more particularly, its outermost portion 40.

The thickness of the wall 44 of the teat nipple 4 has a varying thickness, it is namely larger at the level of the outermost portion 40 and, in particular, in the area pierced with the slit 41.

The wall 44 of the teat nipple 4 thus has an increase of its thickness, called extra thickness 45, the thickness of which, in association with the dimensional characteristics of the slit 41, corresponds to a pressure threshold-value at which the slit 41 lets the foodstuff flow out.

The extra thickness 45 of the wall 44 provides the latter with some rigidity capable of maintaining the slit 41 hermetically closed below a determined pressure value, and of closing the slit 41 when the pressure drops below this value.

Preferably, the slit 41 consists of a straight slit, and the pressure threshold-value is determined by the thickness of the extra thickness 45 and by the length of this slit.

However, the slit 41 may consist of a slit having an S- or Z-shape.

The slit may also have a zigzag shape, so that, when its lips are separated apart, there is brought about not one opening, but several openings, which generate, under the pressure, small jets of liquid food, in a way similar to what occurs at the level of a mother's breast.

According to the invention, for a given material, the flow-rate of the nursing bottle is changed by varying one of the three data representing the thickness of the extra thickness 45, the pressure of aspiration and the length of the slit 41.

Tests have been carried out on classical teat nipples and on teat nipples for a nursing bottle according to the invention, with different dimensional characteristics.

The teat nipples used are made out of the same material, silicone, so that they have the same physical characteristics, in particular as regards elasticity.

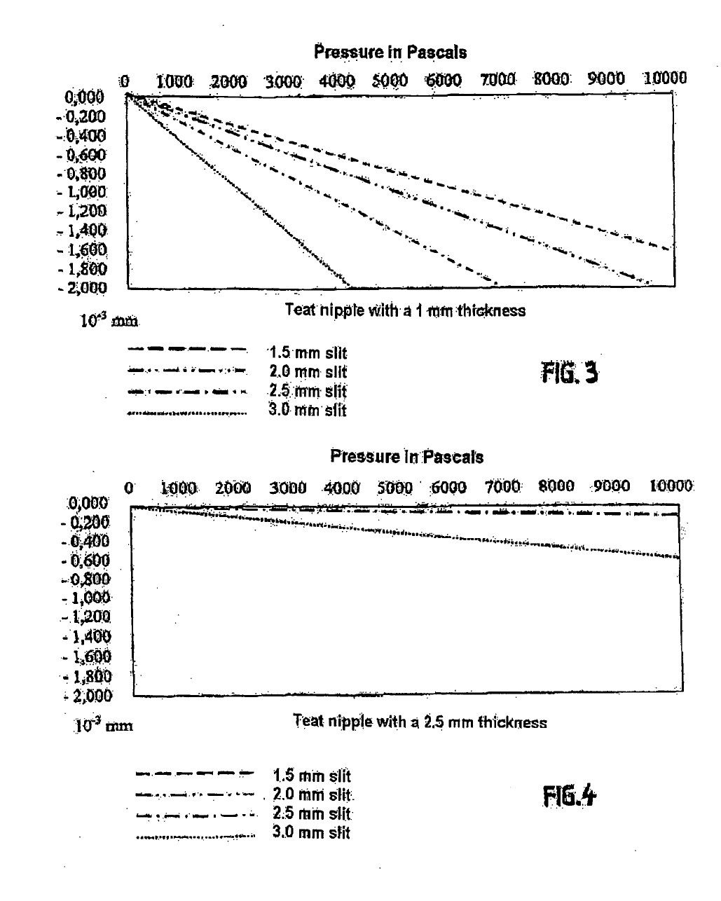

In FIG. 3 have been shown curves corresponding, each to a length of the slit provided for in a classical teat nipple, in this case having a 1 mm thickness, and showing the opening of the slit, expressed in 10⁻³ mm, as a function of the exerted pressure, which is expressed in Pascals.

Knowing that the flow of a liquid of a density close to 1 requires an opening at least equal to 0.1×10^{31 3} mm, one notices that a sufficient opening occurs at pressures, expressed in Pascals, close to 0.

It should be noted that there exist some teat nipples in which the flow occurs even in the absence of any pressure.

When referring now to FIG. 4, one can see curves corresponding, each, to a length of a slit provided for in a teat nipple of a nursing bottle according to the invention, in this case having an extra thickness of 2.5 mm, and showing the opening of the slit as a function of the pressure exerted on the teat nipple.

If the pressure threshold-value for an average age is fixed at 3000 Pa, one can notice that the curve corresponding to a slit length of 3 mm does not allow to achieve the goal sought, since flowing occurs before said threshold value.

It is thus possible to determine combinations of thickness and length of slit, each adapted to an aspiration pressure threshold-value, and hence to a given age of a child. By way of an example, for a teat nipple made out of silicone or natural rubber, for an extra thickness 45 ranging between 1.5and 4 mm, the length of the slit can range between 1.5 and 3 mm. Of course, other combinations are possible, and beyond the above-mentioned ranges.

When referring now to FIG. 5, one can see a teat nipple 6 comprising a nipple portion 60 pierced with a slit 61, and a teat portion 62.

The nipple 60 and teat 62 portions are separated by an intermediate area 63 having a peripheral collar 64 formed of an extra thickness of the wall 65 of the teat nipple 6. This collar 64 contributes to the shape memory of the teat nipple and forms a means for restoring the slit 61 into a closed position. The opening of the slit 61 is achieved through distortion of the nipple portion 60 and, in particular through its elongation, while the collar 64 acts in the opposite direction.

Under the action of relaxation of the pressure exerted by the infant and the elastic restoring of the collar 64, the teat nipple 6 recovers its initial shape, whereas the slit 61 is closed, which causes a negative pressure in the teat nipple 6 and, hence, the opening of the non-return valve 3.

Advantageously, the combination of an extra thickness 45 in the area pierced with the slit and a collar 64 allows achieving a highly efficient second valve.

1. Nursing-bottle comprising:
an open external body accommodating a flexible casing containing fluid foodstuff,
a flexible teat nipple said fluid foodstuff being dispensable therefrom,
a non-return valve arranged between a opening of said flexible casing and said flexible teat nipple and
a second non-return valve close to an end of said flexible teat nipples pierced with at least one slit, said second non-return valve being openable and closable according to whether or not a suction and/or pressure is carried out,
wherein the teat nipple is comprised of means for switching the slit from an imperviously closed position to an open position, in order to authorize passing through of said fluid foodstuff, under the action of a pressure of a predetermined value exerted thereof, the slit being associated with said means for switching and forming said second non-return valve.

2. Device according to claim 1, wherein said means for switching is controllable under the action of a pressure of a given value different from zero and is comprised of an extra thickness of wall of the teat nipple in the area pierced with said slit in association with the dimensional characteristics of said slit and the physical characteristics of the material used, such as namely coefficients of elasticity thereof.

3. Device according to claim 2, wherein the teat nipple is comprised of silicone or natural rubber, and the extra thickness ranges between 1.5 and 8 mm in thickness, while length of the slit ranges between 1.5 and 8 mm.

4. Device according to claim 1, wherein the means for switching is controllable under the action a of a pressure of given value different from zero and is comprised of an extra thickness of the wall of the teat nipple in an area peripheral to an area pierced with said slit, in association with the dimensional characteristics of said slit and the physical characteristics of the material used, such as in particular coefficients of elasticity thereof.

5. Device according to claim 4, wherein the extra thickness has a shape of a collar.

6. Device according to claim 5, wherein said collar is positioned in an area separating a nipple-like portion and a teat-like portion.

7. Device according to claim 1, wherein said slit is a S- or Z-shaped slit.

8. Device according to claim 1, wherein said slit has a zigzag shape.
